(19) United States
(12) Patent Application Publication
(10) Pub. No.: US 2016/0277726 A1
(43) Pub. Date: Sep. 22, 2016

(54) MULTI-PURPOSE EYEWEAR ARTICLE

(71) Applicant: 3nD Technology Limited, Hong Kong (HK)

(72) Inventors: Wing Hon TSANG, Hong Kong (HK); Ka Lun CHAN, Hong Kong (HK)

(21) Appl. No.: 15/169,735

(22) Filed: Jun. 1, 2016

Related U.S. Application Data
(63) Continuation-in-part of application No. 13/600,189, filed on Aug. 30, 2012, now abandoned.

(51) Int. Cl. H04N 13/04

(52) U.S. Cl. CPC H04N 13/044; H04N 13/0434; H04N 2213/001; H04N 2213/008

(57) ABSTRACT

An eyewear article for performing viewing functions is provided. The viewing functions supported include viewing different types of 3D displays, emulating the Pulfrich effect, and viewing a loaded 3D image sequence. The article comprises a left-eye module and a right-eye module, each realized as an optical module comprising one or more liquid crystal layers and one or more linear polarizers. In particular, the number of the one or more linear polarizers is equal to the number of the one or more liquid crystal layers. Optionally, the optical module further includes a matrix-electrode layer on one liquid crystal layer. The matrix-electrode layer is used to form liquid crystal cells, each independently addressable, in the liquid crystal layer. The optical module may further include a multi-color filtering layer. In one option, the light beam passing through the optical module is further processed by a Fresnel lens having a reconfigurable focal length.

### CROSS-REFERENCE TO RELATED APPLICATION

This application is a continuation-in-part of U.S. patent application Ser. No. 13/600,189 filed on Aug. 30, 2012, the disclosure of which is herein incorporated by reference in its entirety.

### FIELD OF THE INVENTION

The present invention relates to an eyewear article reconfigurable for performing a viewing function selected from a plurality of available viewing functions, where the available viewing functions including viewing plural different types of three-dimensional (3D) display.

### BACKGROUND

3D display of images provides an enhanced enjoyable experience for a viewer watching such images compared to viewing conventional two-dimensional images. To allow the viewer to effectively view a 3D image, slightly different images are presented to the left eye and the right eye of the viewer in order that the viewer perceives an illusionary presence of depth. Hereinafter, a left-eye image and a right-eye image are referred to as images that are intended for seeing by the left eye and the right eye, respectively, of the viewer for producing a 3D perception effect.

In a shutter-based 3D display, the display screen alternately displays left-eye images and right-eye images at different time instants. The viewer is required to wear special eyeglasses having a left-eye lens and a right-eye lens arranged to be positioned in front of the left eye and the right eye, respectively, of the viewer. The situation of viewing a shutter-based 3D display is illustrated in FIG. 1. When a left-eye image is displayed on the 3D display, a mechanism is triggered such that the left-eye lens is made transparent whereas the right-eye lens is made opaque. A similar operation is performed by such mechanism when a right-eye image is displayed. By synchronizing the operation of the eyeglasses with the left- and right-eye image display pattern, and by displaying the left- and the right-eye images at a sufficiently high rate, the viewer can perceive the 3D image. This synchronization may be achieved by connecting the display with the eyeglasses by wire, or the eyeglasses may receive the synchronization signal from the display wirelessly.

In a polarization-based 3D display, the left-eye image and the right-eye image are produced by different light beams having mutually orthogonal polarizations. These two images are simultaneously displayed. The situation of viewing a polarization-based 3D display is illustrated in FIG. 2. By placing a polarizer with a polarization orientation the same as that of the left-eye image, the left-eye image is allowed to pass through the polarizer whereas the right-eye image is blocked. A similar operation is used to extract the right-eye image. Therefore, the viewer is allowed to view the 3D image by wearing special eyeglasses where the left- and the right-eye lenses are polarizers having polarization orientations aligned with the polarization orientations of the left- and the right-eye images, respectively.

In an anaglyphic 3D display, the left-eye image and the right-eye image are transmitted in differently-colored light beams and are superimposed together. Extraction of the left- (or right-) eye image from the superimposed image is possible by passing the superimposed image through a color filter having a color matched to the color of the light beam that carries the left- (or right-) eye image. The situation of viewing an anaglyphic 3D display is illustrated in FIG. 3. To enjoy 3D viewing of anaglyphic 3D images, a viewer can wear special eyeglasses having the left- and the right-eye lenses that are color filters matched to the colors of the left- and the right-eye images, respectively.

It is also possible to enable a person to experience a 3D viewing perception by the Pulfrich effect. The Pulfrich effect is a psychophysical phenomenon wherein lateral motion of an object in the field of view is interpreted by the visual cortex as having a depth component, due to a relative difference in signal timings between the two eyes. To achieve the Pulfrich effect, a viewer can wear special eyeglasses having a dark filter placed over one eye. A widely accepted explanation of the apparent depth is that a reduction in retinal illumination (relative to another eye) yields a corresponding delay in signal transmission, imparting instantaneous spatial disparity in moving objects.

For the aforementioned 3D displays and the viewing arrangement based on the Pulfrich effect, the viewer is required to wear eyeglasses specific for each type of display or arrangement that provides a 3D viewing experience. Different pairs of eyeglasses are therefore required. Having different eyeglasses is inconvenient to end users. It is desirable to have a single pair of multi-purpose eyeglasses usable for viewing a variety of 3D displays and/or for inducing the Pulfrich effect. Furthermore, it is advantageous if the single pair of multi-purpose eyeglasses provides additional viewing functions such as acting as sunglasses.

There is a need in the art for such single pair of multi-purpose glasses.

### SUMMARY OF THE INVENTION

An aspect of the present invention is to provide an eyewear article reconfigurable for performing a viewing function selected from a plurality of available viewing functions. The eyewear article comprises a left-eye module and a right-eye module, each realized as an optical module described as follows. The optical module comprises one or more liquid crystal layers each for producing a polarization shift to a light beam traveling therethrough. The polarization shift of an individual liquid crystal layer is modifiable by applying a voltage difference between two opposite surfaces of the individual liquid crystal layer. The optical module further comprises one or more linear polarizers each having a polarization orientation and each for filtering the light beam coming out from one individual liquid crystal layer. In particular, the number of the one or more linear polarizers is equal to the number of the one or more liquid crystal layers. The eyewear article further comprises an electronic controller for controlling the polarization shift of the individual liquid crystal layer of each of the left-eye and the right-eye modules according to the selected viewing function.

In a first embodiment of the present invention, the number of the one or more linear polarizers and the number of the one or more liquid crystal layers in the optical module are both equal to one. The left-eye module has only one linear polarizer regarded as a first linear polarizer, and only one liquid crystal layer regarded as a first liquid crystal layer. Similarly, the right-eye module has only one linear polarizer regarded as a second linear polarizer, and only one liquid crystal layer regarded as a second liquid crystal layer. In addition, the first and second linear polarizers have mutually orthogonal polarization orientations.

For the first embodiment, the available viewing functions include viewing a shutter-based 3D display and viewing a polarization-based 3D display. The electronic controller is configured as follows. A power source coupled to the eyewear article is used for powering the electronic controller. The electronic controller, supplies a first voltage difference between the two opposite surfaces of the first liquid crystal layer, and a second voltage difference between the two opposite surfaces of the second liquid crystal layer. When the power source is absent, both the first voltage difference and the second voltage difference are set to zero volt, thereby enabling a user of the eyewear article to view the polarization-based 3D display. When the power source is present, the electronic controller receives a synchronization signal from the shutter-based 3D display, and sets the first voltage difference and the second voltage difference such that an image is allowed to pass through either the left-eye module or the right-eye module in accordance with the synchronization signal, thereby enabling the user to view the shutter-based 3D display.

In a second embodiment of the present invention, the number of the one or more linear polarizers and the number of the one or more liquid crystal layers in the optical module are both equal to one. The only one linear polarizer of the left-eye module and the only one linear polarizer of the right-eye module have mutually orthogonal polarization orientations. The optical module further comprises a transparent conductive layer coupled to one of the two opposite surfaces of the only one liquid crystal layer, and a matrix-electrode layer coupled to another one of the two opposite surfaces of the only one liquid crystal layer. In addition, the matrix-electrode layer comprises an array of independently addressable electrode regions each being transparent and electrically conductive.

For the second embodiment, the available viewing functions include viewing a shutter-based 3D display and viewing a polarization-based 3D display. The electronic controller is configured as follows. The electronic controller supplies a first reference voltage the transparent conductive layer of the left-eye module, and a second reference voltage to the transparent conductive layer of the right-eye module. When a user of the eyewear article views the shutter-based 3D display, the electronic controller receives a synchronization signal from the shutter-based 3D display, and supplies a first plurality of voltage levels required to drive the independently addressable electrode regions of the left- and the right-eye modules according to the synchronization signal for viewing the shutter-based 3D display. When the user views the polarization-based 3D display, the electronic controller supplies a second plurality of voltage levels required to drive the independently addressable electrode regions of the left- and the right-eye modules for viewing the polarization-based 3D display.

In a third embodiment of the present invention, the number of the one or more linear polarizers and the number of the one or more liquid crystal layers in the optical module are both equal to two. The two linear polarizers are regarded as a first linear polarizer and a second linear polarizer. The two liquid crystal layers are regarded as a first liquid crystal layer and a second liquid crystal layer. In particular, the first and second linear polarizers have mutually orthogonal polarization orientations. Furthermore, the second linear polarizers of the left-eye module and of the right-eye modules have mutually orthogonal polarization orientations. The optical module further comprises: a first transparent conductive layer and a second conductive layer each coupled to one of the two opposite surfaces of the first liquid crystal layer; a third transparent conductive layer coupled to one of the two opposite surfaces of the second liquid crystal layer; and a matrix-electrode layer coupled to another one of the two opposite surfaces of the second liquid crystal layer, wherein the matrix-electrode layer comprises an array of independently addressable electrode regions each being transparent and electrically conductive.

For the third embodiment, the electronic controller is configured as follows. The electronic controller supplies a first reference voltage to the third transparent conductive layer of the left-eye module, a second reference voltage to the third transparent conductive layer of the right-eye module, a third reference voltage to the second transparent conductive layer of the left-eye module, and a fourth reference voltage to the second transparent conductive layer of the right-eye module. The electronic controller further computes a plurality of digital voltage levels required to drive the independently addressable electrode regions and the first transparent conductive layers of the left- and the right-eye modules according to the selected viewing function. A plurality of driving voltages is generated according to the plurality of digital voltage levels, and is supplied to drive the independently addressable electrode regions and the first transparent conductive layers of both the left-eye and the right-eye modules such that the selected viewing function is achieved.

The plurality of available viewing functions may include viewing a shutter-based 3D display and viewing a polarization-based 3D display, and may further include one or more viewing functions selected from emulating the Pulfrich effect for 3D viewing, emulating a pair of pinhole glasses and emulating a pair of sunglasses.

In a fourth embodiment of the present invention, the eyewear article contains the features of the one as set forth in the third embodiment. According to the fourth embodiment, the optical module for the eyewear article further comprises a multi-color filtering layer for filtering the light beam before or after traveling through second liquid crystal layer. The multi-color filtering layer comprises an array of color filters overlying the array of independently addressable electrode regions.

The plurality of available viewing functions may include viewing a shutter-based 3D display and viewing a polarization-based 3D display, and may further include one or more viewing functions selected from viewing an anaglyphic 3D display, emulating the Pulfrich effect for 3D viewing, emulating a pair of pinhole glasses and emulating a pair of sunglasses.

In a fifth embodiment of the present invention, the eyewear article contains the features of the one as set forth in the fourth embodiment. According to the fifth embodiment, the eyewear article further comprises a first Fresnel lens for processing a first light beam entering into or exiting from the left-eye module, and a second Fresnel lens for processing a second light beam entering into or exiting from the right-eye module. Each of the first Fresnel lens and the second Fresnel lens has a focal length that is reconfigurable.

In one option, the focal lengths of the first and the second Fresnel lenses are configured to correct either short-sightedness or long-sightedness of a user of the eyewear article.

When the first Fresnel lens is positioned between the left-eye module and a left eye of the user, and when the second Fresnel lens is positioned between the right-eye module and a right eye of the user, the eyewear article may be used for viewing a loaded 3D image sequence.

Other aspects of the present invention are disclosed as illustrated by the embodiments hereinafter.

### BRIEF DESCRIPTION OF THE DRAWINGS

FIG. 1 illustrates a situation of viewing a shutter-based 3D display.

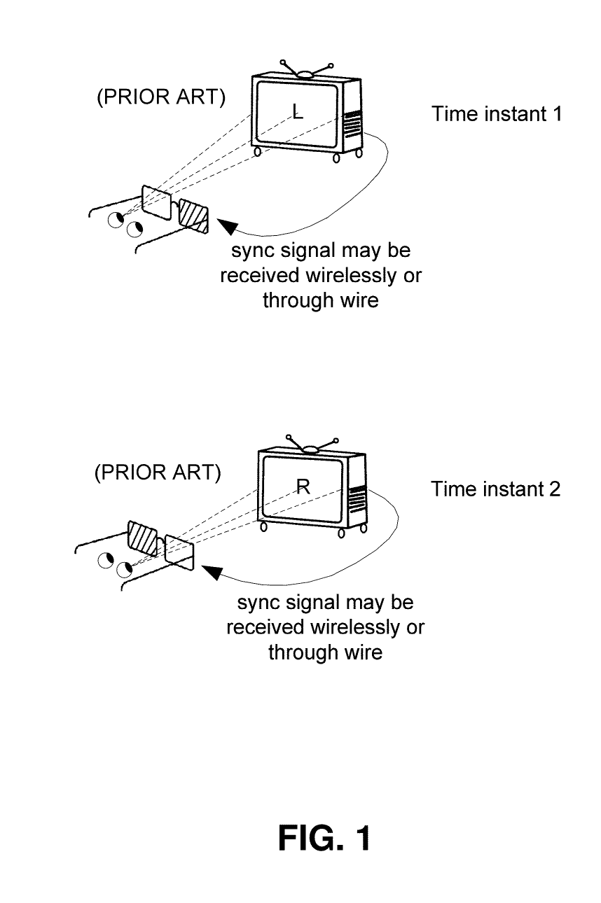

FIG. 2 illustrates a situation of viewing a polarization-based 3D display.

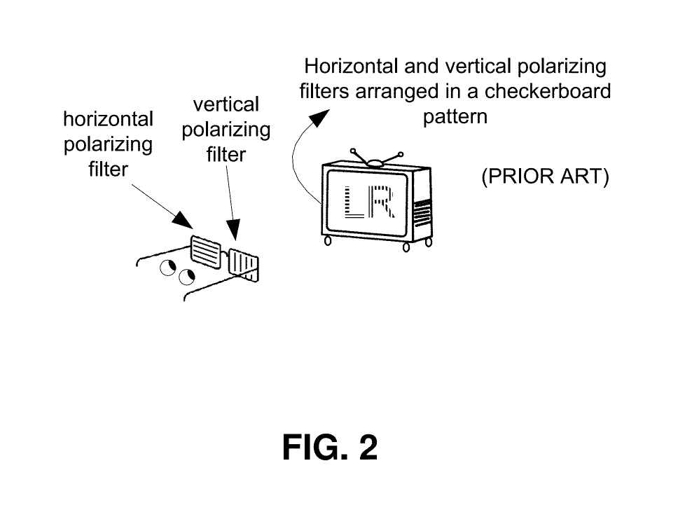

FIG. 3 illustrates a situation of viewing an anaglyphic 3D display.

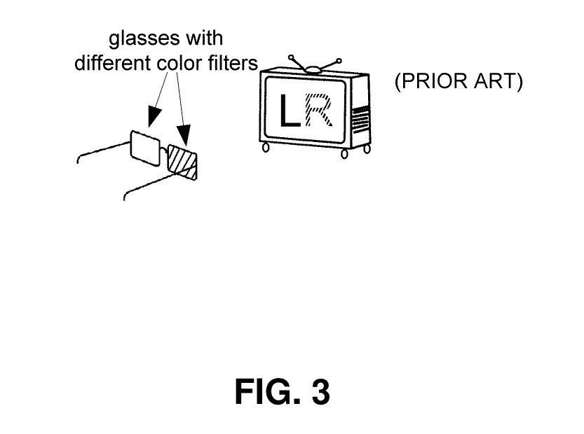

FIG. 4 depicts an optical module according to a first embodiment of the present invention.

FIG. 5 is a schematic diagram exemplarily illustrating an eyewear article using the optical module of FIG. 4. This eyewear article is for enabling a user to view a shutter-based 3D display when a power source is present, or to view a polarization-based 3D display when the power source is absent.

FIG. 6 depicts an optical module according to a second embodiment of the present invention. A 3D view of a matrix-electrode layer used in this optical module is also shown.

FIG. 7 is a schematic diagram exemplarily illustrating an eyewear using the optical module of FIG. 6. This eyewear article is for enabling a user to view a 3D display that is either a shutter-based 3D display or a polarization-based 3D display.

FIG. 8 depicts an optical module according to a third embodiment of the present invention. This optical module is developed substantially based on combining the two optical modules of FIGS. 4 and 6.

FIG. 9 is a schematic diagram exemplarily illustrating an eyewear article using the optical module of FIG. 8. This eyewear article, being reconfigurable, is for performing a viewing function selected from a plurality of available viewing functions.

FIG. 10 depicts an optical module according to a fourth embodiment of the present invention. This optical module is developed on the optical module of FIG. 8 with an addition of a multi-color filtering layer.

FIG. 11 is a prior-art realization of a Fresnel lens for illustration purposes.

FIG. 12 is a schematic diagram exemplarily illustrating an eyewear article according to a fifth embodiment of the invention. This eyewear article is developed on the optical module of FIG. 10 with an addition of a plurality of Fresnel lenses having their focal lengths that are reconfigurable.

FIG. 13 is one realization of a Fresnel lens having a reconfigurable focal length. This realization is based on an array of liquid lenses.

### DETAILED DESCRIPTION

As used herein, in the context of the present invention, the term “an eyewear article” relates to any type of optical filtering device which can be used to produce a 3D viewing effect when used in combination with a displayed image. The eyewear article may be wearable as of eyeglasses or other head-mountable lens structures or, alternatively, the eyewear article may be supported by an object other than the user in such a way that each eye of the user experiences the desired filtering effects to create 3D perception.

In the present invention, a “liquid crystal layer” refers to a layer substantially composed of liquid-crystal molecules wherein the liquid crystal layer is configured to provide a 90-degree polarization shift to a light beam that passes through this liquid crystal layer when a voltage difference between two opposite surfaces of the liquid crystal layer is zero volt. It is possible to apply a non-zero voltage difference to the two opposite surfaces of the liquid crystal layer. Furthermore, it is possible to partition the liquid crystal layer into a plurality of “liquid crystal cells” each of which can be individually applied with a voltage difference between two opposite surfaces thereof. It is used herein that an “untwisting voltage” refers to a voltage sufficiently large to cause a substantial portion of liquid-crystal molecules in a liquid crystal layer or a liquid crystal cell to be reoriented, such that no polarization shift is provided to a light beam that passes through the liquid crystal layer. No polarization shift also results if an external voltage difference is applied between two opposite surfaces of a liquid crystal layer or a liquid crystal cell, where this voltage difference has a magnitude exceeding the untwisting voltage. If this voltage difference has a magnitude between zero volt and the untwisting voltage, the intensity of a light beam passing through the liquid crystal layer or the liquid crystal cell is modulated, thereby providing a method to control the intensity of the light beam.

It is an observation that a present-day shutter-based 3D display is usually a liquid-crystal display so that images produced by such display are produced in polarized light having one polarization orientation. In the present invention, it is considered that a left-eye image and a right-eye image sent out by a shutter-based 3D display are carried by light beams that are linear polarized light having the same polarization orientation. For example, this polarization orientation may be either horizontal polarization or vertical polarization.

In the present invention, it is also considered that a left-eye image and a right-eye image sent out by a polarization-based 3D display are carried by light beams that are linear polarized lights having mutually orthogonal polarization orientations.

The Inventors have observed that when an eyewear article receives light beams from a 3D display, the presence of linear polarization in these light beams allows the eyewear article to receive the light beams directly by one or more liquid crystal layers without a need to first pass through any linear polarizer, so that each liquid crystal layer is only required to be followed by one linear polarizer. In contrast, a commonly-used eyewear article typically has each liquid crystal layer sandwiched by two linear polarizers. This observation has inspired the Inventors that an eyewear article capable of supporting viewing of both a shutter-based 3D display and a polarization-based 3D display is realizable by restricting the number of the one or more liquid crystal layers to be equal to the number of linear polarizers. Furthermore, the Inventors have found that if the number of the one or more liquid crystal layers is restricted to be equal to the number of linear polarizers, cascading a pair of liquid crystal layer and linear polarizer with another pair allows the eyewear article to support a variety of viewing functions.

As mentioned above, a left-eye image and a right-eye image refer to images that are intended for seeing by a left eye and a right eye, respectively, of a viewer for producing a 3D perception effect. In the description of the invention that follows, it is considered that the disclosed eyewear article is configured to present the left-eye image to the left eye and the right-eye image to the right eye. Nonetheless, the viewer may, at his or her wish, reconfigure the disclosed eyewear article to present the left-eye image to the right eye while the right-eye image is presented to the left eye. This reconfiguration becomes apparent to an ordinary person skilled in the art after reading the disclosure of the present invention.

The present invention includes five embodiments, each being a multi-purpose eyewear article. The five embodiments are described as follows. Afterwards, the present invention is elaborated as a generalization of the five embodiments.

### First Embodiment

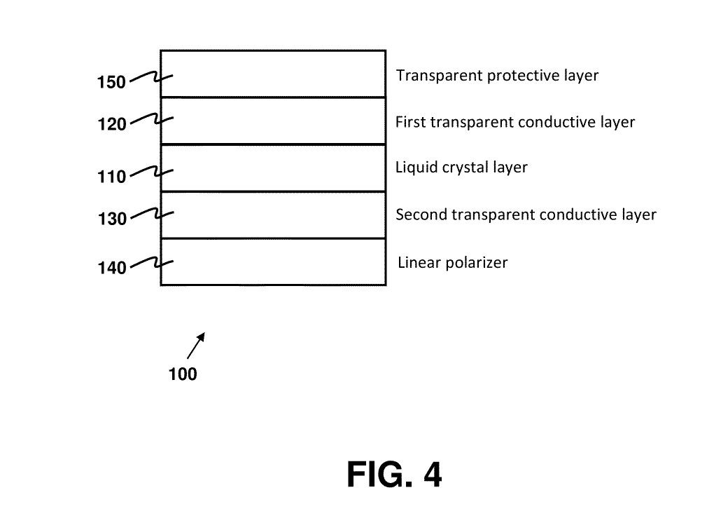

The first embodiment of the present invention is a first multi-purpose eyewear article for enabling a user to view a shutter-based 3D display when a power source is present, or to view a polarization-based 3D display when the power source is absent. This eyewear article is realized based on a first liquid-crystal optical module depicted in FIG. 4.

Refer to FIG. 4. An optical module 100, which is the first liquid-crystal optical module, comprises a liquid crystal layer 110 positioned between a first transparent conductive layer 120 and a second transparent conductive layer 130. Both the first transparent conductive layer 120 and the second transparent conductive layer 130 are optically transparent and electrically conductive. The optical module 100 further comprises a linear polarizer 140 and a transparent protective layer 150. The linear polarizer 140 is characterized by a polarization orientation. In addition, the linear polarizer 140 is attached to the second transparent conductive layer 130 on a surface not attached to the liquid crystal layer 110. The linear polarizer 140 is an optical filter that selectively allows a light beam having a polarization orientation the same as the polarization orientation of the linear polarizer 140 to pass through. The transparent protective layer 150 is attached to the first transparent conductive layer 120 on a surface not attached to the liquid crystal layer 110. This transparent protective layer 150 is for providing mechanical support and protection to the rest of the optical module 100.

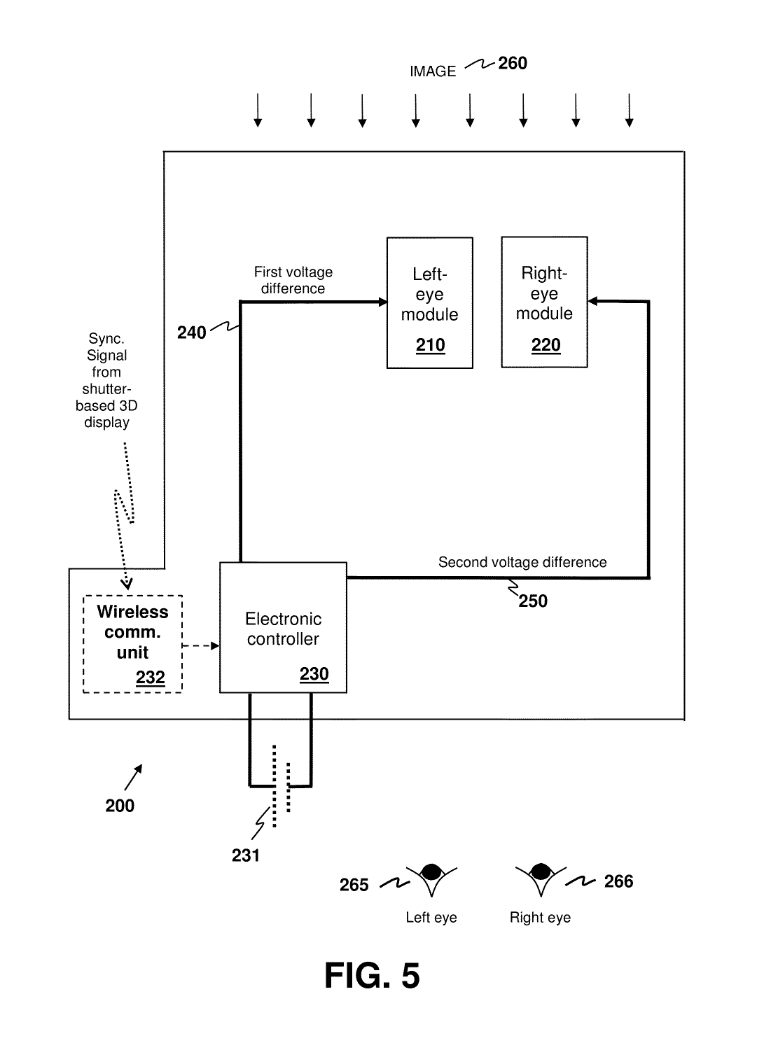

FIG. 5 is a schematic diagram for exemplarily illustrating an eyewear article 200 according to the first embodiment of the present invention. As is mentioned above, this eyewear article 200 enables a user to view a shutter-based 3D display when a power source is present, or to view a polarization-based 3D display when the power source is absent. The eyewear article 200 comprises a left-eye module 210 and a right-eye module 220, each of which is realized according to the optical module 100 described above. The left-eye module 210 is arranged to be positioned in front of a left eye 265 of the user. Similarly, the right-eye module 220 is arranged to be positioned in front of a right eye 266 of the user. A light beam carrying an image 260 enters into the left-eye module 210 and the right-eye module 220. In particular, both modules 210, 220 are oriented to receive the light beam by their transparent protective layers. After the left-eye module 210 produces a first optical effect on the image 260, the resultant image is seen by the left eye 265 of the user. Similarly, a second optical effect is produced on the image 260 by the right-eye module 220 and the resultant image leaving from the right-eye module 220 is seen by the right eye 266 of the user. The eyewear article 200 further comprises an electronic controller 230 for controlling the polarization shift of each liquid crystal layer in the left-eye module 210 and the right-eye module 220. Take the liquid crystal layer 110 as an example. The electronic controller 230 controls the polarization shift of the liquid crystal layer 110 by providing an appropriate voltage difference between the first transparent conductive layer 120 and the second transparent conductive layer 130. This electronic controller 230 is configured to be powered by a power source 231. It is possible that the power source 231 is present or absent. If the power source 231 is absent, the electronic controller 230 is not supplied with a power. The electronic controller 230 is further configured to: receive a synchronization signal from the shutter-based 3D display; supply a first voltage difference 240 between the first and the second transparent conductive layers of the left-eye module 210; and supply a second voltage difference 250 between the first and the second transparent conductive layers of the right-eye module 220. Furthermore, the eyewear article 200 is characterized in that the linear polarizers of the left-eye module 210 and of the right-eye module 220 have mutually orthogonal polarization orientations.

Consider a situation that the power source 231 is absent and the image 260 is originated from the polarization-based 3D display. The image 260 is a composite image comprising a left-eye image and a right-eye image superimposed together, wherein the left-eye image and the right-eye image are carried by different light beams having mutually orthogonal polarization orientations. As a result that the electronic controller 230 does not receive power, the electronic controller 230 sets both the first voltage difference 240 and the second voltage difference 250 to zero volt, so that the liquid crystal layer of either the left-eye module 210 or the right-eye module 220 provides a 90-degree polarization shift to a light beam that passes through such liquid crystal layer. Consequently, the left-eye module 210 allows either the left-eye image or the right-eye image to pass through but not both, and the one of the aforesaid two images that is allowed to pass through is carried by a light beam whose polarization orientation is orthogonal to the polarization orientation of the linear polarizer of the left-eye module 210. In addition, the one of the aforesaid two images that is not allowed to pass through the left-eye module 210 is allowed to pass through the right-eye module 220. Hence, the two eyes of the user are allowed to see separate images, the sum of said separate images constituting the image 260, which originates from the polarization-based 3D display. Thereby, the user is enabled to view the polarization-based 3D display. Optionally, the user may equip with a first eyewear article and a second eyewear article, each of which is a realization of the eyewear article 200. The first eyewear article and the second eyewear article are further characterized in that the linear polarizer of the left-eye module of the first eyewear article is orthogonal in polarization orientation to that of the second eyewear article, also implying that the linear polarizer of the right-eye module of the first eyewear article is orthogonal in polarization orientation to that of the second eyewear article. Therefore, either the first eyewear article or the second eyewear article allows the left-eye image to pass through the left-eye module 210 for the left eye 265 to see, and the right-eye image to pass through the right-eye module 220 for the right eye 266 to see. Thus, the user is enabled to view the polarization-based 3D display with the left-eye image and the right-eye image correctly projected to the two eyes of the user.

Consider another situation that the power source 231 is present and the image 260 is originated from the shutter-based 3D display. In the presence of the power source 231, the electronic controller 230 sets the first voltage difference 240 and the second voltage difference 250 such that the image 260 is allowed to pass through either the left-eye module 210 or the right-eye module 220 in accordance with the shutter-based 3D display's synchronization signal received by the electronic controller 230. To illustrate how the eyewear article 200 facilitates viewing of the shutter-based 3D display, consider a representative case that light beams carrying both the left-eye image and the right-eye image have a common polarization orientation the same as the polarization orientation of the linear polarizer of, say, the left-eye module 210. When the synchronization signal indicates that the shutter-based 3D display is sending out the left-eye image, the electronic controller 230 may set the first voltage difference 240 and the second voltage difference 250 to a voltage whose magnitude exceeds the untwisting voltage. It follows that no polarization shift to the light beams is introduced by the liquid crystal layers of both the left-eye module 210 and the right-eye module 220. Since the linear polarizers of both modules 210, 220 are mutually orthogonal in polarization orientation, and since the common polarization orientation of the carrier light beams is the same as the polarization orientation of the linear polarizer of the left-eye module 210, the left-eye image can pass through the left-eye module 210 and is presented to the left eye 265 while this image is blocked at the right-eye module 220. When the synchronization signal indicates that the shutter-based 3D display is sending out the right-eye image, the electronic controller 230 may set the first voltage difference 240 and the second voltage difference 250 to zero volt. It follows that a 90-degree polarization shift to the carrier light beams is introduced by the liquid crystal layers of either the left-eye module 210 or the right-eye module 220. Hence, the right-eye image can pass through the right-eye module 220 and is presented to the right eye 266 while this image is blocked at the left-eye module 210. Therefore, the eyewear article 200 enables the user to view the shutter-based 3D display. Optionally, the first voltage difference 240 and the second voltage difference 250 can be operated independently for applying to the left-eye module 210 and the right-eye module 220, respectively, to block the image 260 to go to both eyes 265, 266 and hence stop the cross-talk produced when a transient switch between the left-eye image to the right-eye image or vice versa when viewing the shutter-based 3D display. In order to block both eyes from seeing the image 260, according to aforesaid case, the first voltage difference 240 is applied with a zero voltage to the left-eye module 210 for blocking the left eye 265, and the second voltage difference 250 is applied with a voltage exceeding the untwisting voltage to the right-eye module 220 for blocking the right eye 266 at the same time instant. In another case, the first voltage difference 240 and the second voltage difference 250 may be operated to let the image 260 carried by a polarized light beam go to both eyes 265, 266 for non-3D content from a display.

As mentioned above, the electronic controller 230 may receive the synchronization signal from the shutter-based 3D display wirelessly or by wire. If the synchronization signal is received wirelessly, the electronic controller 230 further comprises a wireless communication unit 232. The wireless communication unit 232 may be a radio-frequency wireless receiver or an infra-red receiver.

### Second Embodiment

The second embodiment of the present invention is a second multi-purpose eyewear article for enabling a user to view a 3D display, and a second liquid-crystal optical module for realizing this eyewear article, wherein the 3D display is either a shutter-based 3D display or a polarization-based 3D display.

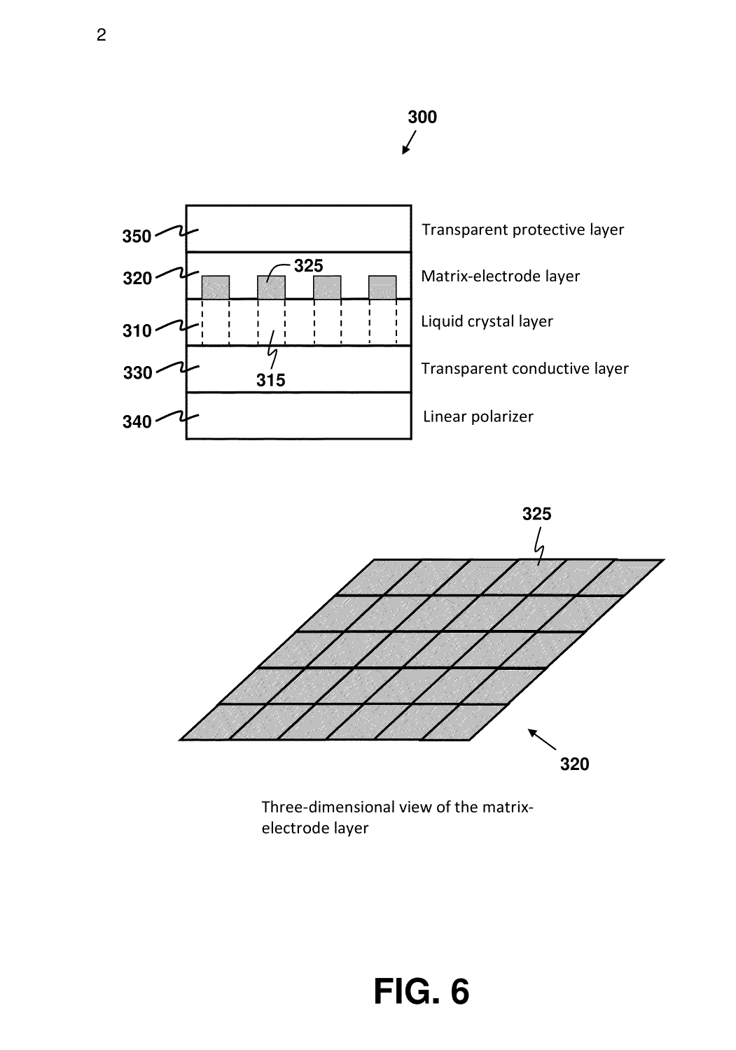

FIG. 6 depicts an optical module 300 according to the second embodiment of the present invention. This optical module 300 comprises a liquid crystal layer 310 positioned between a matrix-electrode layer 320 and a transparent conductive layer 330. The transparent conductive layer 330 is optically transparent and electrically conductive. The matrix-electrode layer 320 comprises an array of independently addressable electrode regions 325, and each of the independently addressable electrode regions 325 is optically transparent and electrically conductive. Furthermore, the independently addressable electrode regions 325 are allowed to be addressable such that a voltage can be applied to any one of these independently addressable electrode regions 325 being addressed. As the liquid crystal layer 310 is positioned between the matrix-electrode layer 320 and the transparent conductive layer 330, a plurality of liquid crystal cells 315 is formed, each of which is a portion of the liquid crystal layer 310 contacted with an independently addressable electrode region 325 of the matrix-electrode layer 320. Notice that each of the liquid crystal cells 315 is independently addressable, and the polarization shift produced by each of the liquid crystal cells 315 is independently controllable. The ability of independently controlling each of the liquid crystal cells 315 in the matrix-electrode layer 320 enables generating a plurality of desirable optical effects on an image processed by the optical module 300, such as masking the image with a certain pattern. The optical module 300 further comprises a linear polarizer 340, which is characterized by a polarization orientation, and a transparent protective layer 350. The linear polarizer 340 is attached to the transparent conductive layer 330 on a surface not attached to the liquid crystal layer 310. The linear polarizer 340 is an optical filter that selectively allows a light beam having a polarization orientation the same as the polarization orientation of the linear polarizer 340 to pass through. The transparent protective layer 350 is attached to the matrix-electrode layer 320 on a surface not attached to the liquid crystal layer 310. This transparent protective layer 350 is for providing mechanical support and protection to the rest of the optical module 300.

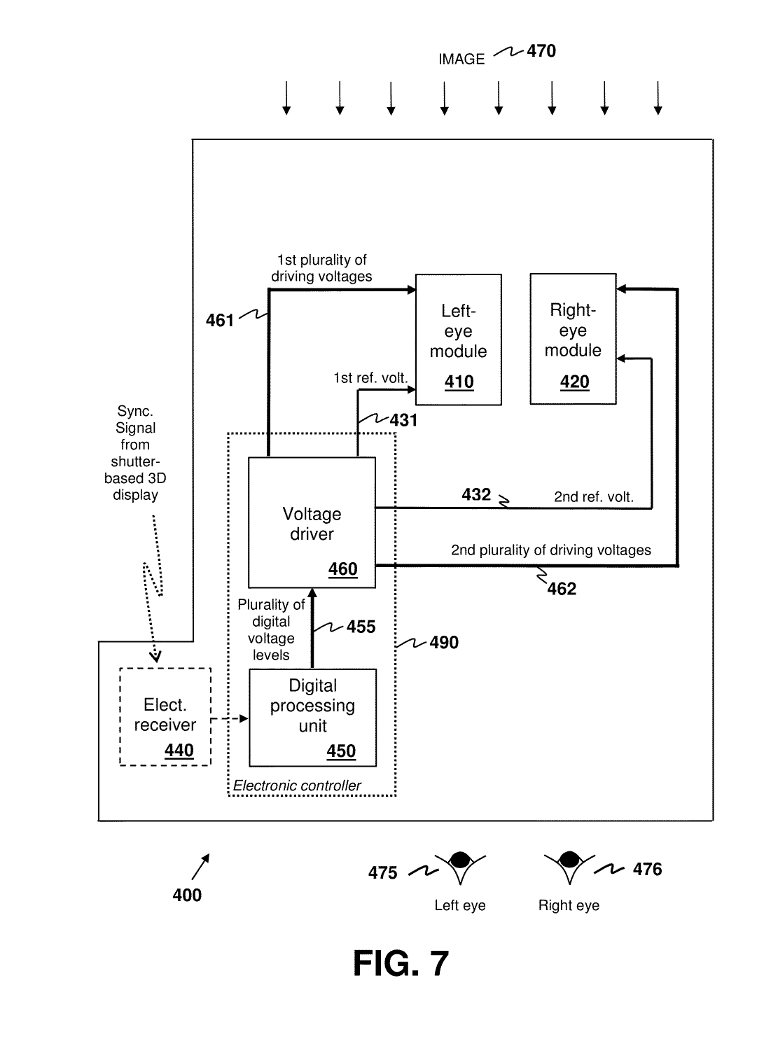

FIG. 7 is a schematic diagram for exemplarily illustrating an eyewear article 400 according to the second embodiment of the present invention. This eyewear article 400 comprises a left-eye module 410 and a right-eye module 420, each of which is realized as the optical module 300 described above, wherein the linear polarizers of the left-eye module 410 and of the right-eye module 420 have mutually orthogonal polarization orientations. The left-eye module 410 is arranged to be positioned in front of a left eye 475 of the user. Similarly, the right-eye module 420 is arranged to be positioned in front of a right eye 476 of the user. A light beam carrying an image 470 enters into the left-eye module 410 and the right-eye module 420. In particular, both modules 410, 420 are oriented to receive the light beam by their transparent protective layers. After the left-eye module 410 produces a first optical effect on the image 470, the resultant image is seen by the left eye 475 of the user. Similarly, a second optical effect is produced on the image 470 by the right-eye module 420 and the resultant image leaving from the right-eye module 420 is seen by the right eye 476 of the user. The eyewear article 400 further comprises an electronic controller 490 for controlling the polarization shift of each liquid crystal layer in the left-eye module 410 and the right-eye module 420. The electronic controller 490 comprises a voltage driver 460 and a digital processing unit 450. The voltage driver 460 supplies a first reference voltage 431 to the transparent conductive layer of the left-eye module 410, and a second reference voltage 432 to the transparent conductive layer of the right-eye module 420. Optionally, the first reference voltage 431 is equal to the second reference voltage 432. The eyewear article 400 further comprises an electronic receiver 440 for receiving a synchronization signal from the shutter-based 3D display. Note that if the polarization-based 3D display is selected for viewing, the shutter-based 3D display may not be present so that the synchronization signal may not be received. The electronic receiver 440 is linked to the digital processing unit 450, and sends the synchronization signal, if received, to the digital processing unit 450. According to the synchronization signal if received, and according to the first reference voltage 431 and the second reference voltage 432, the digital processing unit 450 computes a plurality of digital voltage levels 455 required to drive the independently addressable electrode regions of the left-eye module 410 and of the right-eye module 420 for viewing the 3D display that is selected. The plurality of digital voltage levels 455 is computed based on a substantially similar approach as set out in the first embodiment of the present invention regarding the setting of the first voltage difference and the second voltage difference for both cases of the polarization-based 3D display and of the shutter-based 3D display. According to the plurality of digital voltage levels 455, the voltage driver 460 generates a plurality of driving voltages according to the plurality of digital voltage levels 455, and supplies the plurality of driving voltages to drive the independently addressable electrode regions of both modules 410, 420. The plurality of driving voltages consists of a first plurality of driving voltages 461 supplied to the left-eye module 410, and a second plurality of driving voltages 462 supplied to the right-eye module 420.

Optionally, the left-eye module 410 and the right-eye module 420 may provide an additional effect of masking the image 470 by selectively making the liquid crystal cells of the two optical modules 410, 420 opaque according to a masking pattern before being viewed by the left eye 475 and the right eye 476, respectively, of a user.

### Third Embodiment

A third embodiment of the present invention is a third multi-purpose eyewear article reconfigurable for performing a viewing function selected from a plurality of available viewing functions, and a third liquid-crystal optical module for realizing this eyewear article.

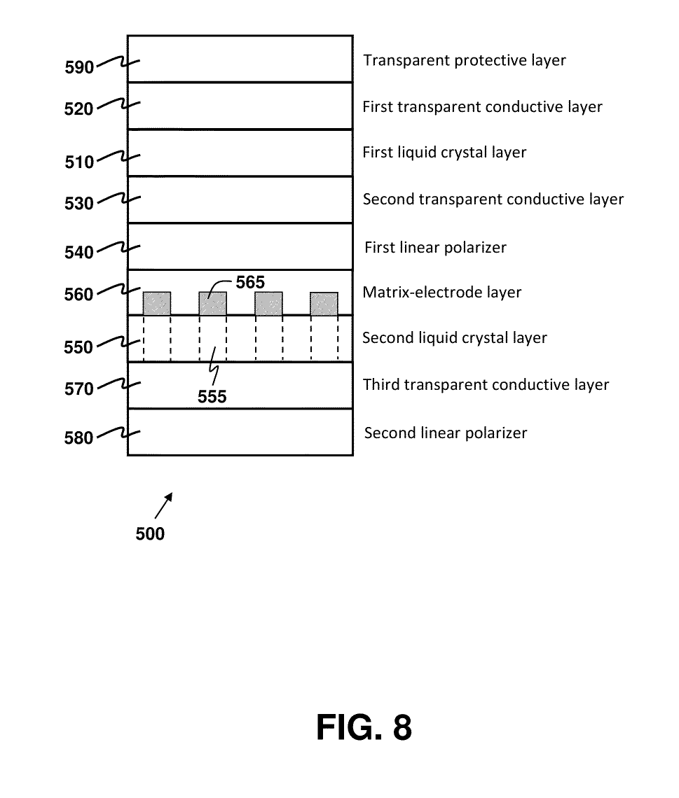

FIG. 8 depicts an optical module 500 according to the third embodiment of the present invention. This optical module 500 is substantially similar to a combination of the optical modules 100, 300 with the following additional features. The optical module 500 comprises a first liquid crystal layer 510 positioned between a first transparent conductive layer 520 and a second transparent conductive layer 530. Both the first transparent conductive layer 520 and the second transparent conductive layer 530 are optically transparent and electrically conductive. The optical module 500 further comprises a first linear polarizer 540, which is characterized by a polarization orientation. The first linear polarizer 540 is attached to the second transparent conductive layer 530 on a surface not attached to the first liquid crystal layer 510. The first linear polarizer 540 is an optical filter that selectively allows a light beam having a polarization orientation the same as the polarization orientation of the first linear polarizer 540 to pass through. The optical module 500 further comprises a second liquid crystal layer 550 positioned between a matrix-electrode layer 560 and a third transparent conductive layer 570. The third transparent conductive layer 570 is optically transparent and electrically conductive. The matrix-electrode layer 560 comprises an array of independently addressable electrode regions 565, and each of the independently addressable electrode regions 565 is optically transparent and electrically conductive. Furthermore, the independently addressable electrode regions 565 are allowed to be addressable such that a voltage can be applied to any one of these independently addressable electrode regions 565 being addressed. As the second liquid crystal layer 550 is positioned between the matrix-electrode layer 560 and the third transparent conductive layer 570, a plurality of liquid crystal cells 555 is formed, each of which is a portion of the second liquid crystal layer 550 contacted with an independently addressable electrode region 565 of the matrix-electrode layer 560. The optical module 500 further comprises a second linear polarizer 580, which is characterized by a polarization orientation, and a transparent protective layer 590. The second linear polarizer 580 is attached to the third transparent conductive layer 570 on a surface not attached to the second liquid crystal layer 550. The second linear polarizer 580 is an optical filter that selectively allows a light beam having a polarization orientation the same as the polarization orientation of the second linear polarizer 580 to pass through. In addition, the second linear polarizer 580 and the first linear polarizer 540 are mutually orthogonal in polarization orientation. The transparent protective layer 590 is attached to the first transparent conductive layer 520 on a surface not attached to the first liquid crystal layer 510. This transparent protective layer 590 is for providing mechanical support and protection to the rest of the optical module 500.

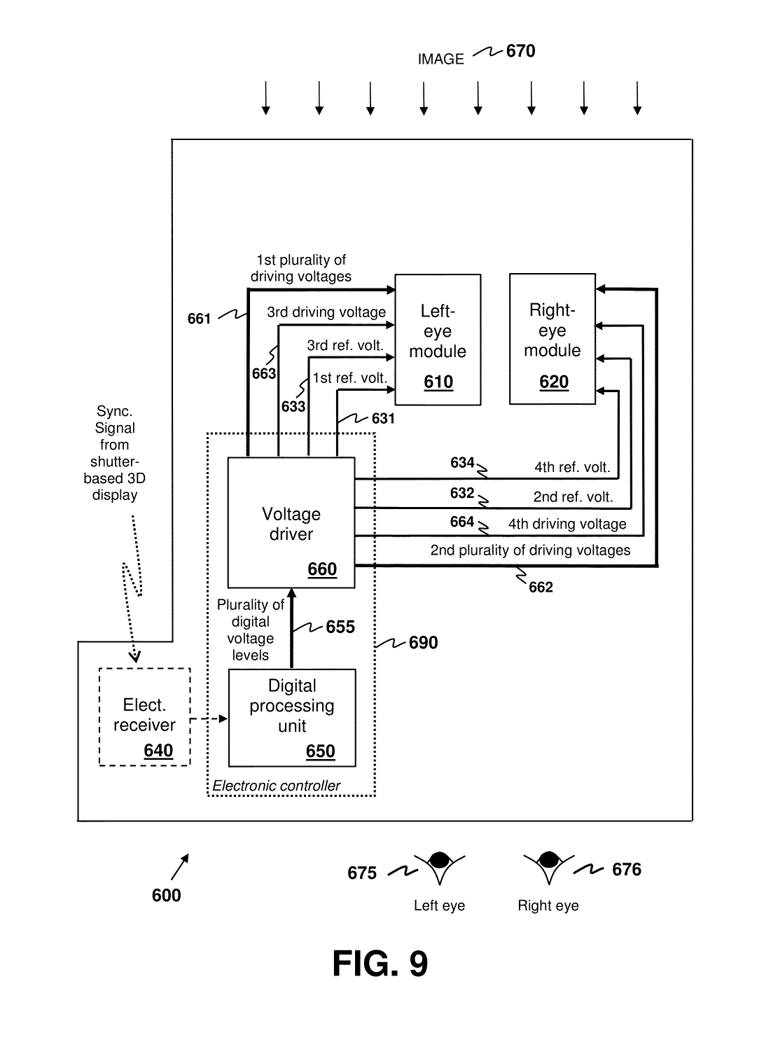

FIG. 9 is a schematic diagram for exemplarily illustrating an eyewear article 600 according to the third embodiment of the present invention. This eyewear article 600 comprises a left-eye module 610 and a right-eye module 620, each of which is realized as the optical module 500 described above, wherein the second linear polarizers of the left-eye module 610 and of the right-eye module 620 have mutually orthogonal polarization orientations. The left-eye module 610 is arranged to be positioned in front of a left eye 675 of the user. Similarly, the right-eye module 620 is arranged to be positioned in front of a right eye 676 of the user. A light beam carrying an image 670 enters into the left-eye module 610 and the right-eye module 620. In particular, both modules 610, 620 are oriented to receive the light beam by their transparent protective layers. After the left-eye module 610 produces a first optical effect on the image 670, the resultant image is seen by the left eye 675 of the user. Similarly, a second optical effect is produced on the image 670 by the right-eye module 620 and the resultant image leaving from the right-eye module 620 is seen by the right eye 676 of the user. The eyewear article 600 further comprises an electronic controller 690 for controlling the polarization shift of each liquid crystal layer in the left-eye module 610 and the right-eye module 620. The electronic controller 690 comprises a voltage driver 660 and a digital processing unit 650. The voltage driver 660 supplies a first reference voltage 631 to the third transparent conductive layer of the left-eye module 610, a second reference voltage 632 to the third transparent conductive layer of the right-eye module 620, a third reference voltage 633 to the second transparent conductive layer of the left-eye module 610, and a fourth reference voltage 634 to the second transparent conductive layer of the right-eye module 620. Optionally, the first reference voltage 631 may be equal to the second reference voltage 632, and the third reference voltage 633 may be equal to the fourth reference voltage 634. It is also optional that the first, the second, the third and the fourth reference voltages 631-634 may all be equal. According to the first, the second, the third and the fourth reference voltages 631-634, the digital processing unit 650 computes a plurality of digital voltage levels 655 required to drive the first transparent conductive layers and the independently addressable electrode regions of the left-eye module 610 and of the right-eye module 620 for performing the viewing function that is selected. According to the plurality of digital voltage levels 655, the voltage driver 660 generates a plurality of driving voltages according to the plurality of digital voltage levels 655, and supplies the plurality of driving voltages to drive the first transparent conductive layers and the independently addressable electrode regions of both modules 610, 620. The plurality of driving voltages consists of a first plurality of driving voltages 661 supplied to the independently addressable electrode regions of the left-eye module 610, a second plurality of driving voltages 662 supplied to the independently addressable electrode regions of the right-eye module 620, a third driving voltage 663 supplied to the first conductive layer of the left-eye module 610, and a fourth driving voltage 664 to the first conductive layer of the right-eye module 620.

Preferably, the plurality of available viewing functions includes viewing a shutter-based 3D display and viewing a polarization-based 3D display. To configure the eyewear article 640 for viewing the shutter-based 3D display, the eyewear article 600 further comprises an electronic receiver 640 configured to receive a synchronization signal from the shutter-based 3D display, and the digital processing unit 650 is further configured to receive the synchronization signal from the electronic receiver 640 to thereby compute the plurality of digital voltage levels 655. There are many ways to set the plurality of driving voltages, and the first, the second, the third and the fourth reference voltages 631-634. An example is given as follows. The first reference voltage 631, the second reference voltage 632, the first plurality of driving voltages 661 and the second plurality of driving voltages 662 may all be set to zero volt, thereby permitting light beams that leave the first linear polarizer to transmit through the second linear polarizer for either the left-eye module 610 or the right-eye module 620. In addition, the third reference voltage 633 and the fourth reference voltage 634 may be set to zero volt, so that the voltage differences experienced by the first liquid crystal layers of the left-eye module 610 and of the right-eye module 620 depend on the third driving voltage 663 and the fourth driving voltage 664, respectively. Consider a situation that the polarization-based 3D display is viewed and the polarization orientation of the left-eye image is the same as the polarization orientation of the first linear polarizer of the left-eye module 610, implying that the polarization orientation of the right-eye image is also the same as the polarization orientation of the first linear polarizer of the right-eye module 620. In this situation, the third driving voltage 663 and the fourth driving voltage 664 may be set to the untwisting voltage, in order to allow the left-eye image and the right-eye image to pass through the first liquid crystal layers of the left-eye module 610 and of the right-eye module 620, respectively. In another situation that the polarization orientation of the left-eye image is orthogonal to the polarization orientation of the first linear polarizer of the left-eye module 610 when viewing the polarization-based 3D display, a light beam carrying the left-eye image is required to have an additional 90-degree phase shift in order not to be blocked by the first linear polarizer of the left-eye module 610, so that the third driving voltage 663 may be set to zero volt. Similarly, the fourth driving voltage 664 may also be set to zero volt for this situation. Consider a situation that the shutter-based 3D display is viewed and the image 670, which may be a left-eye image or a right-eye image, is carried by a light beam having a polarization orientation the same as the polarization orientation of the first linear polarizer of the left-eye module 610, also implying that the polarization orientation of the light beam is orthogonal to the polarization orientation of the first linear polarizer of the right-eye module 620. If the image 670 is a left-eye image, the third driving voltage 663 may be set to the untwisting voltage for allowing the image 670 to pass through the first linear polarizer of the left-eye module 610, while the fourth driving voltage 664 may also be set to the untwisting voltage to block the image 670 from leaving the first linear polarizer of the right-eye module 620. Similarly, if the image 670 is the right-eye image when viewing the shutter-based 3D display, the third driving voltage 663 and the fourth driving voltage 664 may both be set to zero volt. Optionally, the left-eye module 610 and the right-eye module 620 may be operated independently to block the image 670 to go to both eyes 675, 676 and hence stop the cross-talk produced when a transient switch between the left-eye image to the right-eye image or vice versa when viewing the shutter-based 3D display. In order to block both eyes from seeing the image 670, the first plurality of driving voltages 661 may be set to have a first common voltage, and at the same time instant the second plurality of driving voltages 662 may be set to have a second common voltage, wherein a voltage difference between the first common voltage and the first reference voltage 631 exceeds the untwisting voltage, and a voltage difference between the second common voltage and the second reference voltage 632 exceeds the untwisting voltage. In another case, the third reference voltage 633, the third driving voltage 663, the fourth reference voltage 634 and the fourth driving voltage 664 may be operated to let the image 670 carried by a polarized light beam go to both eyes 675, 676 for non-3D content from a display, given that the first plurality of driving voltages 661 is set to have a third common voltage equal to the first reference voltage 631, and the second plurality of driving voltages 662 is set to have a fourth common voltage equal to the second reference voltage 632. Optionally, the image 670 from the shutter-based 3D display may be carried by a light beam that is not polarized. In this case, the third reference voltage 633, the fourth reference voltage 634, the third driving voltage 663 and the fourth driving voltage 664 may be set at any voltage level, while the first plurality of driving voltages 661 may be set to have a fifth common voltage and the second plurality of driving voltages 662 may be set to have a sixth common voltage. When it is intended that the image 670 is allowed to pass through the left-eye module 610, a voltage difference between the fifth common voltage and the first reference voltage 631 may be set to zero volt. When it is intended that the image 670 is blocked from leaving the left-eye module 610, a voltage difference between the fifth common voltage and the first reference voltage 631 may be set to a value exceeding the untwisting voltage. When it is intended that the image 670 is allowed to pass through the right-eye module 620, a voltage difference between the sixth common voltage and the second reference voltage 632 may be set to zero volt. When it is intended that the image 670 is blocked from leaving the right-eye module 620, a voltage difference between the sixth common voltage and the second reference voltage 633 may be set to a value exceeding the untwisting voltage.

Preferably, the plurality of available viewing functions further includes emulating the Pulfrich effect for 3D viewing. To emulate the Pulfrich effect, the left-eye module 610 and the right-eye module 620 have different degrees of light transmission. Different from viewing a shutter-based or a polarization-based 3D display, the image 670 is carried by a light beam that is not necessarily polarized. There are many ways to set the plurality of driving voltages, and the first, the second, the third and the fourth reference voltages 631-634. An example is given as follows. The first reference voltage 631, the second reference voltage 632, the first plurality of driving voltages 661 and the second plurality of driving voltages 662 may all be set to zero volt, thereby permitting light beams that leave the first linear polarizer to transmit through the second linear polarizer for either the left-eye module 610 or the right-eye module 620. In addition, the third reference voltage 633 and the fourth reference voltage 634 may be set to zero volt, so that the voltage differences experienced by the first liquid crystal layers of the left-eye module 610 and of the right-eye module 620 depend on the third driving voltage 663 and the fourth driving voltage 664, respectively. If the image 670 is carried by a light beam that is not polarized, modifying the third driving voltage 663 and the fourth driving voltage 664 does not change the degrees of light transmission of the left-eye module 610 and the right-eye module 620, respectively. As such, the third driving voltage 663 and the fourth driving voltage 664 may both be set to zero volt. Hence, the first plurality of driving voltages 661 and the second plurality of driving voltages 662 may be set to be different values within zero volt and the untwisting voltage relative to the first reference voltage 631 and the second reference voltage 632, respectively.

Preferably, the plurality of available viewing functions further includes emulating a pair of sunglasses. To emulate the pair of sunglasses, it is required to adjust the left-eye module 610 and the right-eye module 620 to have a same degree of light transmission less than 100%. Different from viewing a shutter-based or a polarization-based 3D display, the image 670 is carried by a light beam that is not necessarily polarized. There are many ways to set the plurality of driving voltages, and the first, the second, the third and the fourth reference voltages 631-634. An example is given as follows. The first reference voltage 631, the second reference voltage 632, the first plurality of driving voltages 661 and the second plurality of driving voltages 662 may all be set to between zero volt and the untwisting voltage, thereby adjusting intensity of the light beams that leave the first linear polarizer to transmit through the second linear polarizer for either the left-eye module 610 and the right-eye module 620. In addition, the third reference voltage 633 and the fourth reference voltage 634, relative to the third driving voltage 663 and the fourth driving voltage 664, respectively, may be set to zero volt. If the image 670 is carried by a light beam that is not polarized, adjusting the left-eye module 610 and the right-eye module 620 to have a same degree of light transmission less than 100% can be achieved by setting the third driving voltage 663 and the fourth driving voltage 664 to a same voltage level within zero volt and the untwisting voltage.

Optionally, the left-eye module 610 and the right-eye module 620 may provide an additional effect of masking the image 670 by selectively making the liquid crystal cells of the two optical modules 610, 620 opaque according to a masking pattern before being viewed by the left eye 675 and the right eye 676, respectively, of a user.

Preferably, the plurality of available viewing functions further includes emulating a pair of pinhole glasses. In the pair of pinhole glasses, both the left-eye image and the right-eye image are masked by a masking pattern having one or more small holes that allow the passage of light, while the light is blocked outside these small holes. Small apertures of the small holes produce an optical effect that allows a user to view a distant object more clearly, thereby somehow mitigating adverse effects due to the user's short-sightedness, if present. Note that the distant object, presented as the image 670, is carried by a light beam that is not necessarily polarized. There are many ways to set the plurality of driving voltages, and the first, the second, the third and the fourth reference voltages 631-634. An example is given as follows. For simplicity, the first reference voltage 631 and the second reference voltage 632 may be set at zero volt. The first plurality of driving voltages 661 and the second plurality of driving voltages 662 supplied to the independently addressable electrode regions of the matrix-electrode layers of the left-eye module 610 and of the right-eye module 620, respectively, may be set as follows. According to the masking pattern, the independently addressable electrode regions that correspond to the small holes, which allow passage of light, are provided with zero volt, and the rest of the independently addressable electrode regions are supplied with the untwisting voltage. If the image 670 is carried by a light beam that is polarized, the third reference voltage 633, the fourth reference voltage 634, the third driving voltage 663 and the fourth driving voltage 664 may be set at any voltage level without affecting the viewing function of emulating the pair of pinhole glasses.

### Fourth Embodiment

The fourth embodiment of the present invention is a fourth multi-purpose eyewear article reconfigurable for performing a viewing function selected from a plurality of available viewing functions, and a fourth liquid-crystal optical module for realizing this eyewear article.

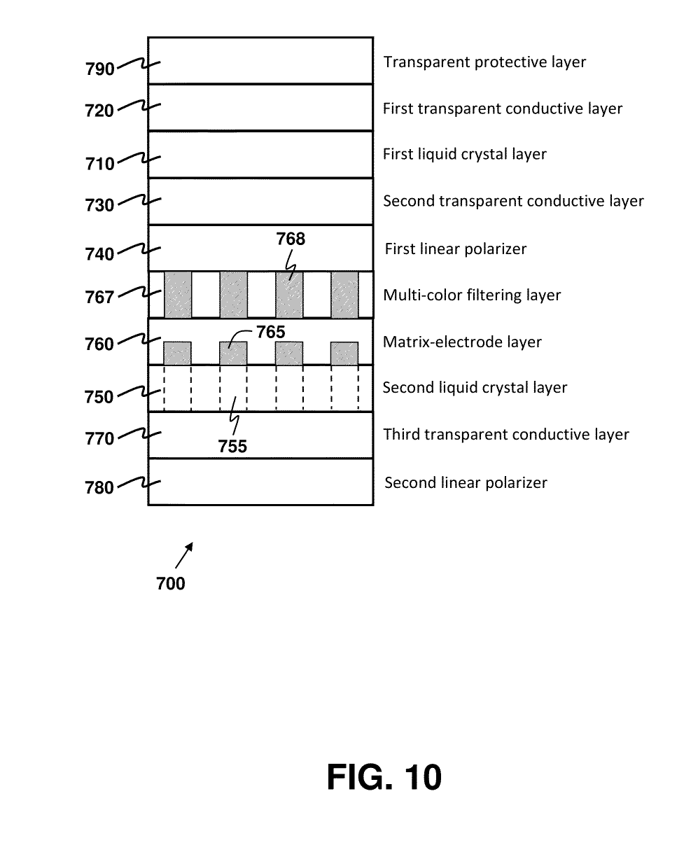

FIG. 10 depicts an optical module 700 according to the fourth embodiment of the present invention. The optical module 700 incorporates the details of the optical module 500 disclosed above in the third embodiment of this invention, and further comprises a multi-color filtering layer 767 positioned between the first linear polarizer 740 and the matrix-electrode layer 760, wherein the multi-color filtering layer 767 comprises an array of color filters 768 overlying the array of independently addressable electrode regions 765. Preferably, each of the independently addressable electrode regions 765 is covered by a color filter out of the array of color filters 768. Preferably, each of the color filters 768 has a color of either red, green or blue. The colors of the color filters 768 are arranged evenly, or according to one of the known color filter patterns, over the entirety of the color filters 768, thereby allowing three consecutive color filters having colors of red, green and blue to be grouped together as a pixel. It follows that a colorful image is realizable when a white light beam passes through the optical module 700.

The fourth multi-purpose eyewear article disclosed herein incorporates the details of the eyewear article 600 disclosed above for the third embodiment of the present invention, except that each of the left-eye and the right-eye modules of the fourth multi-purpose eyewear article is realized as the optical module 700 described above.

Preferably, the plurality of available viewing functions includes viewing a shutter-based 3D display and viewing a polarization-based 3D display. Preferably, the plurality of available viewing functions further includes one or more viewing functions selected from emulating the Pulfrich effect for 3D viewing, emulating a pair of pinhole glasses and emulating a pair of sunglasses. Details of configuring the fourth multi-purpose eyewear article for viewing the shutter-based 3D display, viewing the polarization-based 3D display, emulating the Pulfrich effect for 3D viewing, emulating the pair of pinhole glasses and emulating the pair of sunglasses are substantially similar to the corresponding details disclosed above in the third embodiment of this invention.

Preferably, the plurality of available viewing functions further includes viewing an anaglyphic 3D display. As mentioned above, extraction of a left- (right-) eye image from a superimposed image sent out by the anaglyphic 3D display is done by passing the superimposed image through a color filter having a color matched to the color of a light beam that carries the left- (right-) eye image. The fourth multi-purpose eyewear article may extract the left- (right-) eye image from the superimposed image by the following setting. A third transparent conductive layer 770 of a left- (right-) eye optical module may be set at zero volt. Zero volt may be applied to a matrix-electrode layer 760's independently addressable electrode regions 765 that overlay color filters 768 having a same color matched to the color of the light beam that carries the left- (right-) eye image, thereby allowing a part of the light beam to pass through liquid crystal cells 755 that attach to these independently addressable electrode regions 765. The untwisting voltage may be applied to remaining independently addressable electrode regions 765 on the matrix-electrode layer 760, so that another part of the light beam entering into liquid crystal cells that attach to these remaining independently addressable electrode regions 765 is blocked.

### Fifth Embodiment

The fifth embodiment of the present invention is a fifth multi-purpose eyewear article reconfigurable for performing a viewing function selected from a plurality of available viewing functions, wherein this eyewear article includes a plurality of Fresnel lens to perform one or more optical effects.

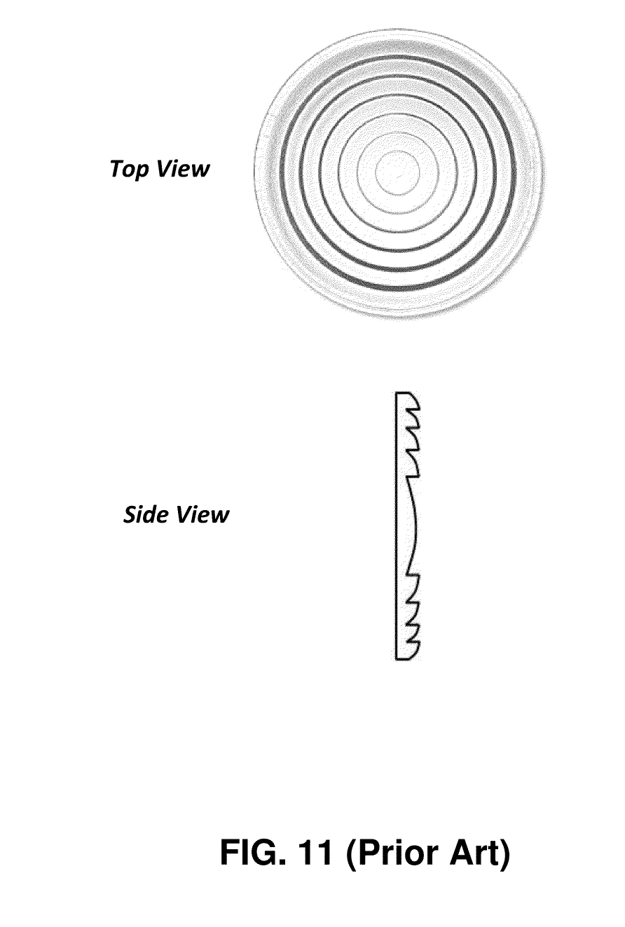

For illustration, FIG. 11 depicts a top view and a side view of a prior-art realization of a Fresnel lens. The Fresnel lens has an advantage for use as a lens having a large aperture and a short focal length in that the mass and the volume of material required to construct the lens are reduced over conventional designs, thereby allowing the Fresnel lens to be thin and light-weight. These two properties make the Fresnel lens advantageous for use in the fifth multi-purpose eyewear article disclosed herein.

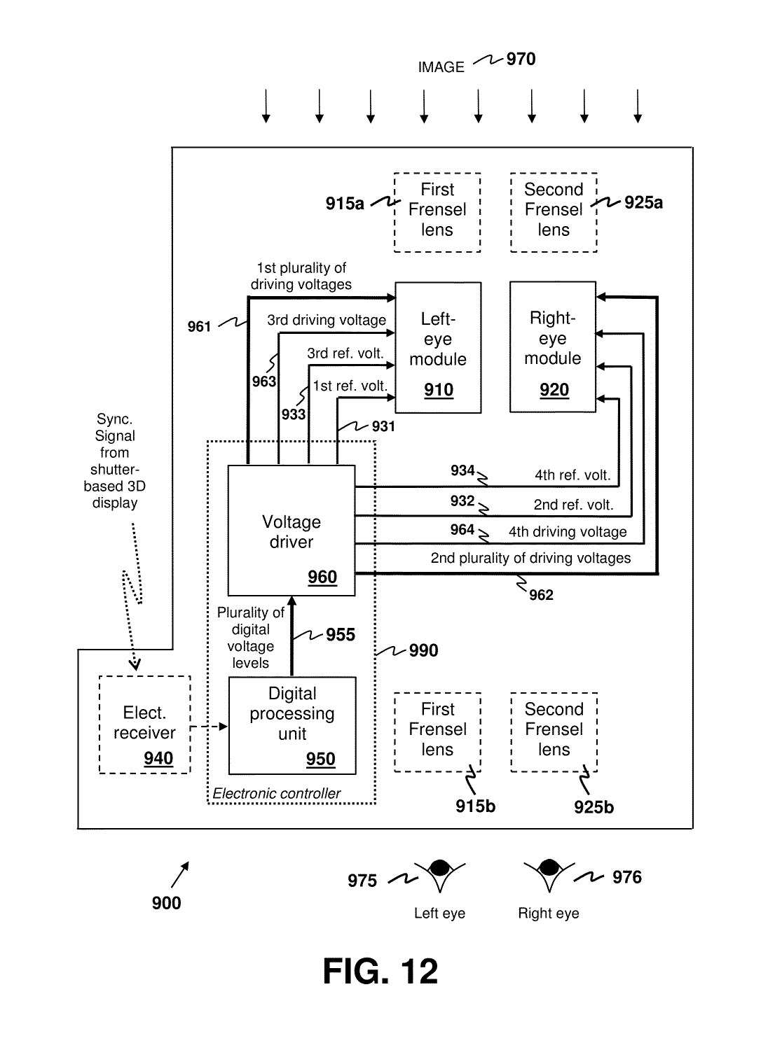

FIG. 12 is a schematic diagram for exemplarily illustrating an eyewear article 900 according to the fifth embodiment of the present invention. The eyewear article 900 incorporates the details of the fourth multi-purpose eyewear article disclosed above in the fourth embodiment of the present invention. It follows that the eyewear article 900 comprises: a left-eye and module 910 and a right-eye module 920 each realized as the optical module 700 described above; and an electronic controller 990 for controlling the polarization shift of each liquid crystal layer in the left-eye module 910 and the right-eye module 920, where the electronic controller 990 comprises a voltage driver 960 and a digital processing unit 950. The voltage driver 960 supplies a first reference voltage 931 to the third transparent conductive layer of the left-eye module 910, a second reference voltage 932 to the third transparent conductive layer of the right-eye module 920, a third reference voltage 933 to the second transparent conductive layer of the left-eye module 910, and a fourth reference voltage 934 to the second transparent conductive layer of the right-eye module 920. Optionally, the first reference voltage 931 may be equal to the second reference voltage 932, and the third reference voltage 933 may be equal to the fourth reference voltage 934. It is also optional that the first, the second, the third and the fourth reference voltages 931-934 may all be equal. According to the first, the second, the third and the fourth reference voltages 931-934, the digital processing unit 950 computes a plurality of digital voltage levels 955 required to drive the first transparent conductive layers and the independently addressable electrode regions of the left-eye module 910 and of the right-eye module 920 for performing the viewing function that is selected. According to the plurality of digital voltage levels 955, the voltage driver 960 generates a plurality of driving voltages according to the plurality of digital voltage levels 955, and supplies the plurality of driving voltages to drive the first transparent conductive layers and the independently addressable electrode regions of both modules 910, 920. The plurality of driving voltages consists of a first plurality of driving voltages 961 supplied to the independently addressable electrode regions of the left-eye module 910, a second plurality of driving voltages 962 supplied to the independently addressable electrode regions of the right-eye module 920, a third driving voltage 963 supplied to the first conductive layer of the left-eye module 910, and a fourth driving voltage 964 to the first conductive layer of the right-eye module 920.

In particular, the eyewear article 900 further comprises a first Fresnel lens 915 (either 915a or 915b) and a second Fresnel lens 925 (either 925a or 925b). The first Fresnel lens 915 is positioned to be adjacent to either the transparent protective layer or the second linear polarizer of the left-eye module 910. If positioned to be adjacent to the transparent protective layer of the left-eye module 910, the first Fresnel lens 915a receives an image 970 and passes a resultant image to the left-eye module 910. If positioned to be adjacent to the second linear polarizer of the left-eye module 910, the first Fresnel lens 915b optically processes an image leaving the left-eye module 910 before being seen by a left eye 975. Similarly, the second Fresnel lens 925 is positioned to be adjacent to either the transparent protective layer or the second linear polarizer of the right-eye module 920. If positioned to be adjacent to the transparent protective layer of the right-eye module 920, the second Fresnel lens 925a receives an image 970 and passes a resultant image to the right-eye module 920. If positioned to be adjacent to the second linear polarizer of the right-eye module 920, the second Fresnel lens 925b optically processes an image leaving the right-eye module 920 before being seen by a right eye 976. Herein in the description of the first Fresnel lens 915 and the second Fresnel lens 925, and in the appended claims, “positioned to be adjacent to” refers to a positional relationship that a first object is close to a second object, but not necessarily that the first object is physically attached to or contacted the second object. In addition, each of the first Fresnel lens 915 and the second Fresnel lens 925 is further characterized by having a focal length that is reconfigurable.

Preferably, the focal lengths of the first Fresnel lens 915 and of the second Fresnel lens 925 may be arranged to correct either short-sightedness or long-sightedness, if present, of a user who wears the eyewear article 900.

For the fifth multi-purpose eyewear article, preferably the plurality of available viewing functions includes viewing a shutter-based 3D display and viewing a polarization-based 3D display. Preferably, the plurality of available viewing functions further includes one or more viewing functions selected from viewing an anaglyphic 3D display, emulating the Pulfrich effect for 3D viewing, emulating a pair of pinhole glasses and emulating a pair of sunglasses. Details of configuring the fifth multi-purpose eyewear article for viewing the shutter-based 3D display, viewing the polarization-based 3D display, viewing the anaglyphic 3D display, emulating the Pulfrich effect for 3D viewing, emulating the pair of pinhole glasses and emulating the pair of sunglasses are substantially similar to the corresponding details disclosed above in the fourth embodiment of this invention.

In one realization, the first Fresnel lens 915 of the eyewear article 900 is arranged to be positioned between the left-eye module 910 and the left eye 975 (i.e. the first Fresnel lens 915b in FIG. 12) of a user, and the second Fresnel lens 925 is arranged to be positioned between the right-eye module 920 and the right eye 976 (i.e. the second Fresnel lens 925b in FIG. 12) of the user. In this realization, preferably the plurality of available viewing functions includes viewing a loaded 3D image sequence. When the viewing function of viewing a loaded 3D image sequence is selected, the digital processing unit 950 of the eyewear article 900 is further configured to receive a sequence of 3D images where each 3D image consists of a left-eye image and a right-eye image, so that the plurality of digital voltage levels 955 is computed for displaying the left-eye image at the left-eye module 910 and the right-eye image at the right-eye module 920. Furthermore, the first Fresnel lens 915b optically relocates the left-eye image displayed at the left-eye module 910 away from the left eye 975, and the second Fresnel lens 925b optically relocates the right-eye image displayed at the right-eye module 920 away from the right eye 976. Such optical relocation is necessary for the user to properly view the left-eye image and the right-eye image; otherwise the two images would appear to be too close to the eyes 975, 976 and the eyes 975, 976 would fail to focus on the two images. Such relocation is achieved through adjustment of the focal lengths of the first Fresnel lens 915b and of the second Fresnel lens 925b.

In the aforementioned realization, preferably the plurality of available viewing functions includes viewing a shutter-based 3D display and viewing a polarization-based 3D display. To configure the eyewear article 900 for viewing the shutter-based 3D display, the eyewear article 900 further comprises an electronic receiver 940 configured to receive a synchronization signal from the shutter-based 3D display, and the digital processing unit 950 is further configured to receive the synchronization signal from the electronic receiver 940 to thereby compute the plurality of digital voltage levels 955.

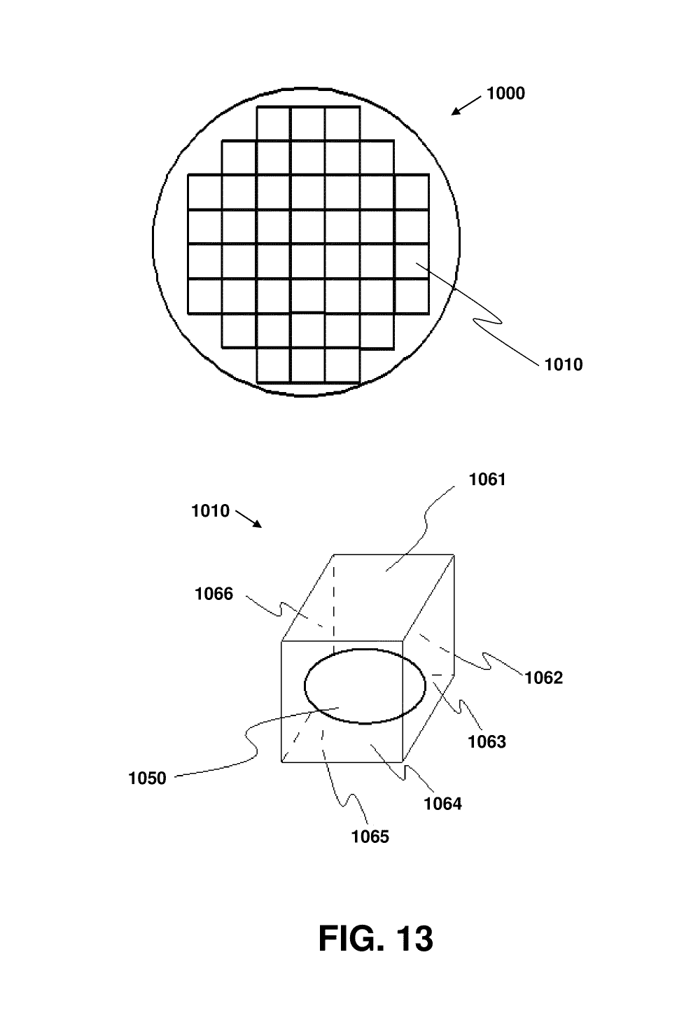

An example to realize a Fresnel lens having a reconfigurable focal length is described with the aid of FIG. 13. In FIG. 13, a Fresnel lens 1000 comprises an array of liquid lenses 1010. In an inset of FIG. 13, an enlarged view of a liquid lens 1010 is shown. The liquid lens 1010 is shaped as a cube comprising six transparent conductive surfaces 1061-1066, wherein the six transparent conductive surfaces 1061-1066 are not electrically connected among themselves. It follows that different voltages may be applied to the six transparent conductive surfaces 1061-1066. Inside the liquid lens 1010, there is a non-conductive liquid drop 1050 that is substantially transparent and has a refractive index greater than that of air. The non-conductive liquid drop 1050 is responsive to the voltages applied to the six transparent conductive surfaces 1061-1066, and changes its shape accordingly. The shape of the liquid drop 1050 determines the liquid drop 1050's power to focus and redirect light beams that enter the liquid lens 1010. To reconfigure the focal length of the Fresnel lens 1000, the focusing and light-redirecting powers may first be determined for the plurality of liquid lenses 1010. The desired voltages for the six transparent conductive surfaces 1061-1066 of each of the liquid lenses 1010 in the Fresnel lens 1000 may then be determined. By applying a plurality of desired voltages to the six transparent conductive surfaces 1061-1066 for all the liquid lenses 1010, the focal length of the Fresnel lens 1000 can be reconfigured as desired.

### The Present Invention

The present invention is elaborated as a generalization of the five embodiments disclosed above.

An aspect of the present invention is to provide an eyewear article reconfigurable for performing a viewing function selected from a plurality of available viewing functions. Examples of an individual viewing function include viewing a shutter-based 3D display, viewing a polarization-based 3D display, superimposing a masking pattern onto an image viewed by a user of the eyewear article, viewing an anaglyphic 3D display, emulating the Pulfrich effect for 3D viewing, emulating a pair of pinhole glasses, emulating a pair of sunglasses, and viewing a loaded 3D image sequence.

The eyewear article comprises a left-eye module and a right-eye module. Each of the left-eye and the right-eye modules is realized as an optical module comprising one or more liquid crystal layers, and one or more linear polarizers. The one or more liquid crystal layers are used for producing a polarization shift to a light beam traveling therethrough. The polarization shift of an individual liquid crystal layer is modifiable by applying a voltage difference between two opposite surfaces of the individual liquid crystal layer. Each of the one or more linear polarizers has a polarization orientation and is used for filtering the light beam coming out from one individual liquid crystal layer. In particular, according to the present invention, it is required that the number of the one or more linear polarizers is equal to the number of the one or more liquid crystal layers. The eyewear article further includes an electronic controller for controlling the polarization shift of the individual liquid crystal layer of each of the left-eye and the right-eye modules according to the selected viewing function.

If the eyewear article is implemented in accordance with the first embodiment or the second embodiment of the present invention, the number of the one or more linear polarizers and the number of the one or more liquid crystal layers in the optical module are both equal to one. If the article is realized in accordance with the third, the fourth or the fifth embodiment, the number of the one or more linear polarizers and the number of the one or more liquid crystal layers in the optical module are both equal to two.

As disclosed in detailing the five embodiments above, the electronic controller may include a digital processing unit and a voltage driver. The voltage driver is used for providing analog voltages to the left-eye module and the right-eye module so as to control the polarization shift of the individual liquid crystal layer. The digital processing unit is used for computing digital voltage levels so as to enable the left-eye module and the right-eye module to achieve the selected viewing function. The digital voltage levels are received by the voltage driver to generate the analog voltages.

The voltage driver is implementable by one skilled in the art according to existing knowledge in the art.

The digital processing unit is a computing device including one or more processors for performing computing and controlling functions. The one or more processors may be implemented using general purpose or specialized computing devices, computer processors, computing servers, or electronic circuitries including but not limited to digital signal processors (DSP), application specific integrated circuits (ASIC), field programmable gate arrays (FPGA), and other programmable logic devices configured or programmed according to the teachings of the present disclosure.

The present invention may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. An eyewear article reconfigurable for performing a viewing function selected from a plurality of available viewing functions, comprising:
a left-eye module and a right-eye module, each realized as an optical module comprising:
(a) one or more liquid crystal layers each for producing a polarization shift to a light beam traveling therethrough, the polarization shift of an individual liquid crystal layer being modifiable by applying a voltage difference between two opposite surfaces of the individual liquid crystal layer; and
(b) one or more linear polarizers each having a polarization orientation and each for filtering the light beam coming out from one individual liquid crystal layer, wherein the number of the one or more linear polarizers is equal to the number of the one or more liquid crystal layers;
and
an electronic controller for controlling the polarization shift of the individual liquid crystal layer of each of the left-eye and the right-eye modules according to the selected viewing function.

2. The eyewear article of claim 1, wherein:
the number of the one or more linear polarizers and the number of the one or more liquid crystal layers in the optical module are both equal to one, so that:
(a) the left-eye module has only one linear polarizer regarded as a first linear polarizer, and only one liquid crystal layer regarded as a first liquid crystal layer; and
(b) the right-eye module has only one linear polarizer regarded as a second linear polarizer, and only one liquid crystal layer regarded as a second liquid crystal layer;
the first and second linear polarizers have mutually orthogonal polarization orientations;
the available viewing functions include viewing a shutter-based 3D display and viewing a polarization-based 3D display; and
the electronic controller is configured to:
(a) be powered by a power source coupled to the eyewear article;
(b) supply a first voltage difference between the two opposite surfaces of the first liquid crystal layer, and a second voltage difference between the two opposite surfaces of the second liquid crystal layer;
(c) when the power source is absent, set both the first voltage difference and the second voltage difference to zero volt, thereby enabling a user of the eyewear article to view the polarization-based 3D display; and
(d) when the power source is present, receive a synchronization signal from the shutter-based 3D display, and set the first voltage difference and the second voltage difference such that an image is allowed to pass through either the left-eye module or the right-eye module in accordance with the synchronization signal, thereby enabling the user to view the shutter-based 3D display.

3. The eyewear article of claim 2, further comprising:
a radio-frequency wireless receiver or an infra-red receiver, for receiving the synchronization signal from the shutter-based 3D display.

4. The eyewear article of claim 1, wherein:
the number of the one or more linear polarizers and the number of the one or more liquid crystal layers in the optical module are both equal to one, so that the optical module has only one liquid crystal layer and only one linear polarizer;
the only one linear polarizer of the left-eye module and the only one linear polarizer of the right-eye module have mutually orthogonal polarization orientations;
the optical module further comprises:
(a) a transparent conductive layer coupled to one of the two opposite surfaces of the only one liquid crystal layer; and
(b) a matrix-electrode layer coupled to another one of the two opposite surfaces of the only one liquid crystal layer, wherein the matrix-electrode layer comprises an array of independently addressable electrode regions each being transparent and electrically conductive;
the available viewing functions include viewing a shutter-based 3D display and viewing a polarization-based 3D display; and
the electronic controller is configured to:
(a) supply a first reference voltage to the transparent conductive layer of the left-eye module, and a second reference voltage to the transparent conductive layer of the right-eye module;
(b) when a user of the eyewear article views the shutter-based 3D display, receive a synchronization signal from the shutter-based 3D display, and supply a first plurality of voltage levels required to drive the independently addressable electrode regions of the left- and the right-eye modules according to the synchronization signal for viewing the shutter-based 3D display; and
(c) when the user views the polarization-based 3D display, supply a second plurality of voltage levels required to drive the independently addressable electrode regions of the left- and the right-eye modules for viewing the polarization-based 3D display.

5. The eyewear article of claim 4, wherein:
the available viewing functions further include superimposing a masking pattern onto an image viewed by the user; and
the electronic controller is further configured to generate the first plurality of voltage levels and the second plurality of voltage levels according to the masking pattern.

6. The eyewear article of claim 1, wherein:
the number of the one or more linear polarizers and the number of the one or more liquid crystal layers in the optical module are both equal to two, the two linear polarizers being regarded as a first linear polarizer and a second linear polarizer, the two liquid crystal layers being regarded as a first liquid crystal layer and a second liquid crystal layer, wherein the first and second linear polarizers have mutually orthogonal polarization orientations;
the optical module further comprises:
(a) a first transparent conductive layer and a second conductive layer each coupled to one of the two opposite surfaces of the first liquid crystal layer;
(b) a third transparent conductive layer coupled to one of the two opposite surfaces of the second liquid crystal layer; and
(c) a matrix-electrode layer coupled to another one of the two opposite surfaces of the second liquid crystal layer, wherein the matrix-electrode layer comprises an array of independently addressable electrode regions each being transparent and electrically conductive;
the second linear polarizers of the left-eye module and of the right-eye modules have mutually orthogonal polarization orientations; and
the electronic controller is configured to:
(a) supply a first reference voltage to the third transparent conductive layer of the left-eye module, a second reference voltage to the third transparent conductive layer of the right-eye module, a third reference voltage to the second transparent conductive layer of the left-eye module, and a fourth reference voltage to the second transparent conductive layer of the right-eye module;
(b) compute a plurality of digital voltage levels required to drive the independently addressable electrode regions and the first transparent conductive layers of the left- and the right-eye modules according to the selected viewing function; and
(c) generating a plurality of driving voltages according to the plurality of digital voltage levels, and supplying the plurality of driving voltages to drive the independently addressable electrode regions and the first transparent conductive layers of both the left-eye and the right-eye modules such that the selected viewing function is achieved.

7. The eyewear article of claim 6, wherein:
the plurality of available viewing functions includes viewing a shutter-based 3D display and viewing a polarization-based 3D display;
the eyewear article further comprises an electronic receiver for receiving a synchronization signal from the shutter-based 3D display; and
the electronic controller is further configured such that when the selected viewing function is viewing the shutter-based 3D display, the plurality of digital voltage levels is computed according to the received synchronization signal.

8. The eyewear article of claim 7, wherein the plurality of available viewing functions further includes one or more viewing functions selected from emulating the Pulfrich effect for 3D viewing, emulating a pair of pinhole glasses and emulating a pair of sunglasses.

9. The eyewear article of claim 6, wherein the optical module further comprises a multi-color filtering layer for filtering the light beam before or after traveling through second liquid crystal layer, the multi-color filtering layer comprising an array of color filters overlying the array of independently addressable electrode regions.

10. The eyewear article of claim 9, wherein:
the plurality of available viewing functions includes viewing a shutter-based 3D display and viewing a polarization-based 3D display;
the eyewear article further comprises an electronic receiver for receiving a synchronization signal from the shutter-based 3D display; and
the electronic controller is further configured such that when the selected viewing function is viewing the shutter-based 3D display, the plurality of digital voltage levels is computed according to the received synchronization signal.

11. The eyewear article of claim 10, wherein the plurality of available viewing functions further includes one or more viewing functions selected from viewing an anaglyphic 3D display, emulating the Pulfrich effect for 3D viewing, emulating a pair of pinhole glasses and emulating a pair of sunglasses.

12. The eyewear article of claim 9, further comprising:
a first Fresnel lens for processing a first light beam entering into or exiting from the left-eye module;
a second Fresnel lens for processing a second light beam entering into or exiting from the right-eye module;
wherein each of the first Fresnel lens and the second Fresnel lens has a focal length that is reconfigurable.

13. The eyewear article of claim 12, wherein:
the plurality of available viewing functions includes viewing a shutter-based 3D display and viewing a polarization-based 3D display;
the eyewear article further comprises an electronic receiver for receiving a synchronization signal from the shutter-based 3D display; and
the electronic controller is further configured such that when the selected viewing function is viewing the shutter-based 3D display, the plurality of digital voltage levels is computed according to the received synchronization signal.

14. The eyewear article of claim 13, wherein the focal lengths of the first and the second Fresnel lenses are configured to correct either short-sightedness or long-sightedness of a user of the eyewear article.

15. The eyewear article of claim 14, wherein the plurality of available viewing functions further includes one or more viewing functions selected from viewing an anaglyphic 3D display, emulating the Pulfrich effect for 3D viewing, emulating a pair of pinhole glasses and emulating a pair of sunglasses.

16. The eyewear article of claim 12, wherein:
the first Fresnel lens is arranged to be positioned between the left-eye module and a left eye of a user of the eyewear article; and
the second Fresnel lens is arranged to be positioned between the right-eye module and a right eye of the user.

17. The eyewear article of claim 16, wherein:
the plurality of available viewing functions includes viewing a loaded 3D image sequence;
the electronic controller is further configured to receive a sequence of 3D images where each 3D image consists of a left-eye image and a right-eye image, so that the plurality of digital voltage levels is computed for displaying the left-eye image at the left-eye module and the right-eye image at the right-eye module when the selected viewing function is viewing the loaded 3D image sequence;
the first Fresnel lens optically relocates the left-eye image displayed at the left-eye module away from a left eye of a user of the eyewear article; and
the second Fresnel lens optically relocates the right-eye image displayed at the right-eye module away from a right eye of the user.

18. The eyewear article of claim 17, wherein:
the plurality of available viewing functions further includes viewing a shutter-based 3D display and viewing a polarization-based 3D display;
the eyewear further comprises an electronic receiver for receiving a synchronization signal from the shutter-based 3D display; and
the electronic controller is further configured to receive the synchronization signal from the electronic receiver to thereby compute the plurality of digital voltage levels when the selected viewing function is viewing the shutter-based 3D display.

19. The eyewear article of claim 12, wherein each of the first and the second Fresnel lenses comprises an array of liquid lenses.
